(19) United States
(12) Patent Application Publication
(10) Pub. No.: US 2005/0055870 A1
(43) Pub. Date: Mar. 17, 2005

(54) Light attractant insect trap

(76) Inventor: Alvar Yelverton, Sacramento, CA (US)

Correspondence Address: MCDONOUGH, HOLLAND & ALLEN, 555 CAPITOL MALL, 9TH FLOOR, SACRAMENTO, CA, 95814, US

(21) Appl. No.: 10/841,202

(22) Filed: May 7, 2004

Related U.S. Application Data
(63) Continuation-in-part of application No. 09/680,073, filed on Oct. 6, 2000, now abandoned.

(51) Int. Cl. A01M 1/04

(52) U.S. Cl. 43/113

(57) ABSTRACT

An insect trapping device having a light source, a liquid container disposed beneath the light source having an open surface, and means for preventing the light source from being viewed from a position normal to the axis, wherein light from the light source is reflected from the surface of a liquid placed in said liquid container, and wherein the reflected light is visible when viewed from a position normal to the axis.

### CROSS-REFERENCE TO RELATED APPLICATIONS

This application is a continuation in part of U.S. patent application Ser. No. 09/680,073.

### BACKGROUND OF THE INVENTION

1. Field of the Invention

This invention is an insect trap for night flying insects (star navigators). This configuration is intended for residential use.

2. Description of Related Art

There have been many inventions developed to reduce the presence of pesky insects. Sticky flypaper, citronella candles, pesticide sprays, 1450 watt electric grid bug zappers are some of the commonly used devices.

Traps Using Pesticides or Chemicals:

A search of prior art listed in the U.S. Patent Office database revealed many mechanisms, which incorporate the use of pesticides or harsh chemicals.

U.S. Pat. No. 4,157,629, Parks (1979) uses an ultraviolet light mounted over water containing a petroleum-based liquid. Insects are attracted to the light and are trapped in the petroleum chemical solution. This patent includes processes for avoiding overflow of the petroleum product onto the surrounding surfaces.

The device in U.S. Pat. No. 5,425,197, Smith (1995) attracts insects by light illuminating an adhesive surface. The adhesive surface advances continuously within the device, to avoid a build-up of trapped insects.

The Ecolab traps, U.S. Pat. No. 5,365,690, Nelson et al (1994) and U.S. Pat. No. 5,505,017, Nelson et al (1996), use reflected and radiated light to attract insects into an open container and onto an adhesive surface which has been treated with insect attractant (pheronome) and insecticide.

Inventor Vickery, U.S. Pat. No. 5,209,010 (1993) uses a fan mounted on the lid of a transparent bottle to attract insects into the bottle using liquid scent attractants. The insects are stunned by “striking means” attached to the fan and knocked into the attractant liquid within the bottle to drown.

In U.S. Pat. No. 5,900,243, Yoder et al (1999), the narration describes various types of chemicals which may be used for repelling or killing insect pests.

Other patents for devices incorporating light to attract insects to entrapment on a sticky substance include the following U.S. Pat. No. 4,686,789, Williams (1987); U.S. Pat. No. 5,335,445, Kuepper (1994); U.S. Pat. No. 5,628,142, Kitterman et al (1997); U.S. Pat. No. 5,651,211, Regan et al (1997); U.S. Pat. No. 5,915,948, Kunze et al (1999); U.S. Pat. No. 5,950,355 and U.S. Pat. No. 5,974,727, Gilbert (1999).

Traps Using Electric Grids:

Electric bug zappers by various manufacturers use an electrified grid and an ultraviolet bug light originally developed for attracting insects by the General Electric Company. These zappers have the disadvantage of an annoying presence caused both by the exposed light and the “zap” sound as the insects are killed by contact with the 1450 watt grid. This device because of the high wattage requirements uses considerably more electricity than the invention proposed herein.

The Bugvac, U.S. Pat. No. 5,255,468, Chesire (1993) was designed with a ultraviolet light source, a fan which forced the attracted insects into narrow openings onto an electric grid.

A similar configuration without the electric grid is described in U.S. Pat. No. 5,014,460, Patti et al (1991). (All Tech Industries) includes an omnidirectional light source and a fan which accelerates air into a funnel shaped container. Insects attracted to the light, are forced by the velocity of the air movement into a base container.

The design in U.S. Pat. No. 6,050,025, Wilbanks (2000) simulates the breathing and body heat of animals to attract insects which are subsequently electrocuted.

Traps Using Attractant Light Source Over Liquid:

U.S. Pat. No. 4,366,643, Boaz (1983) is similar to my currently proposed device in its use of florescent light to attract insects set over a container of oil or other liquid in which the insects drown. However, in the Boaz configuration, insects would be attracted to any surface surrounding the light. There is, in this design, inadequate shielding of the light from the light so that the insects could be attracted to any adjacent surface, i.e., wall, trees, thus reducing the efficiency of the trap.

In U.S. Pat. No. 4,086,720, Wiser (1978) light is used to attract insects into a space in which a pump-driven stream of water rains down, forcing the insects into a water reservoir to which an insecticide has been added. This design, like the previous one, does not limit the reflective surfaces affected by the light source.

The Pestolite for indoor use, U.S. Pat. No. 4,332,100, Schneider (1982) operates by attracting insects to a horizontal ultraviolet light source within a container. The insects are then forced by fan-driven air flow into a water-filled tray. The light in this device is also reflected onto other surfaces.

In summary, the disadvantages of the prior art include:
1. The use of pesticides or strong chemicals hazardous to humans and small animals.
2. The use of more electrical energy to run fans, pumps or high wattage grids.
3. Containers that do not restrict the reflected light to the interior of the bug trap container, thus allowing insects to be attracted also to the light reflected on surrounding surfaces, walls, trees, etc.

### SUMMARY OF THE INVENTION

This present invention combines prior art in a unique way to provide an energy efficient, chemically safe, and highly effective device for reducing the numbers of night flying insects (star navigators) in the residential outdoor or indoor environment. It features an ultraviolet light mounted within a dark but partially open container. Through the opening in the container, night flying insects are attracted to the reflection of the ultraviolet light on the surface of water to which a surfactant has been added. The surfactant eliminates the surface tension on the water and the insects once on the water are unable to fly away and become trapped in the water.

An insect trapping device having a light source, a liquid container disposed beneath the light source having an open surface, and means for preventing the light source from being viewed from a position normal to the axis, wherein light from the light source is reflected from the surface of a liquid placed in said liquid container, and wherein the reflected light is visible when viewed from a position normal to the axis.

In one preferred embodiment, the device has a lining of the liquid container is coated with a light reflecting material. In a further preferred embodiment, the remaining interior surfaces of the device are coated with a light absorbing material.

The light source preferably emits light in an ultraviolet spectrum that lures night flying insects to the liquid surface.

In a further preferred embodiment, the means for preventing the light source from being viewed from a position normal to the axis comprises a light occluding barrier surrounding the perimeter of the light source.

In a different embodiment, the insect trapping device has a vertical axis with a light source positioned over a liquid container open to the surface along the axis, wherein the device comprises means for preventing the light source from being viewed from a distance from the device, wherein light from the light source is reflected from the surface of a liquid placed in the aid liquid container, and wherein surface reflected light is visible when viewed at the distance from the device.

The means for preventing the light source from being viewed from a distance from the device preferably comprises a light occluding barrier surrounding the perimeter of said light source.

These and other features and advantages of this invention are described in, or are apparent from, the following detailed description of various exemplary embodiments of the apparatus and methods according to this invention.

### BRIEF DESCRIPTION OF THE DRAWINGS

FIG. 1A (isometric view) Shows the underside of the removable lid of the insect trap container. A fluorescent light fixture with ultraviolet light bulb is mounted on the inside of the lid. The inside of the lid would be a matte black.

FIG. 1B (elevation) This is a cross section of the lid illustrating the fluorescent fixture. Sight line is from the back of the fixture.

FIG. 2A (isometric view) Illustrates the assembled trap, lid in place. Viewed inside, through the side opening, is the light colored container of water and a surfactant.

FIG. 2B (isometric view) Viewed in cross section from slightly behind center, inside the trap is a white reservoir containing water to which a surfactant has been added; this container is placed about 6 inches below a fluorescent fixture with a ultraviolet bulb (black light) which is attached to the lid of the trap.

FIG. 3A (elevation, front) This shows the insect trap in one configuration, visualized as constructed of a heavy plastic material. An opening into the interior of the trap allows flying insects to enter when attracted by the light reflected on the water surface. The interior of the trap is matte black.

FIG. 3B (cross-section, from right side) This cross-section viewed from the right side cuts through the light fixture and the water container. The type of light bulb used, the relative distance from the light to the surface of the water, the use of a surfactant, the reflective surface of the water container, the non-reflective interior surface of the trap enclosure are the unique features of this design.

FIG. 4 (elevation, from right side) The side view illustrates the appearance of the trap with limited access into the attractant light reflection from the front side.

Wherein the reference numerals used in the drawings are as follows:
10 The bottom section of the trap which contains the water vessel and admits insects
12 A removable lid inside which the florescent light fixture is mounted
14 The fluorescent light fixture with ultraviolet light bulb
16 Removable, white pan to contain water with surfactant
18 Cord for light, 110, grounded
20 Opening into body of trap, through which insects are attracted by light reflection
22 Marquis or overhang which obscures direct view of the ultraviolet light bulb

### DETAILED DESCRIPTION OF THE PREFERRED EMBODIMENT

The drawings attached depict the best mode contemplated by this inventor. Prototypes have been built in both metal or plastic utilizing existing lidded containers. The final version will depend on manufacturing techniques required to economically produce this for home use.

The components of this insect trap and the function of each are as follows:

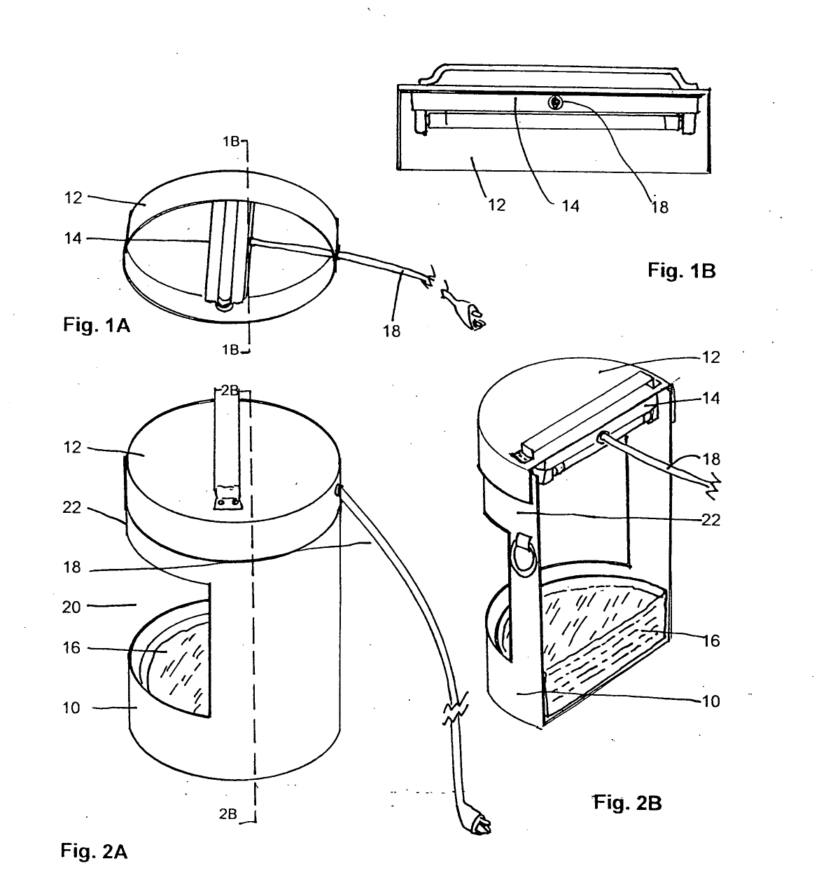

Cover or Lid (FIGS. 1A, 1B)

The cover of the trap (12) houses the bulb and its mounting bracket (14). This cover prevents the UV rays from shining upward and reflecting upon any surface above the trap. Otherwise, the insects would cling to the reflection on objects outside the trap and never reach the water. The inside surface of the cover (FIG. 1A) should be a non-reflective black to prevent insects from being attracted to the inside of the cover.

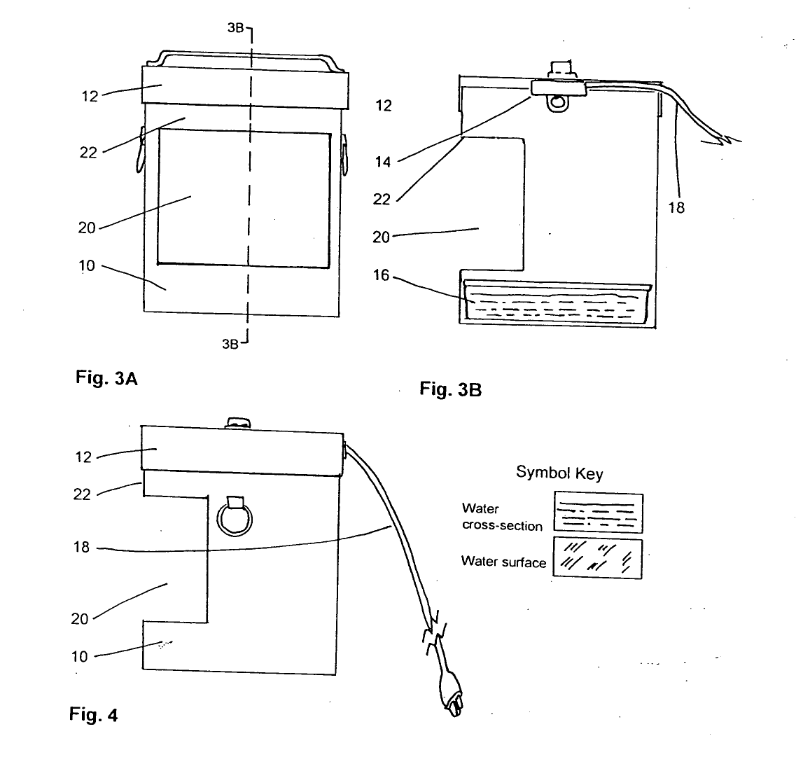

Supporting Walls (FIGS. 2A, 2B, 3B)

The walls of the trap enclose the water basin (16) and support the cover (12) or lid. The walls must be strong enough to accomplish this and also support the enclosed water basin (16) when the trap is lifted. The inside surfaces of these walls, should be nonreflective black (FIGS. 2B, 3B) to prevent insects from being attracted to the walls and not to the water surface below. The outside colors and texture (FIGS. 2A, 3A, 4) of the insect trap are not critical and could any color or texture desired.

The Bottom (FIGS. 2B, 3B)

The lower part of the walls are a continuation of the sides and connect to the bottom to enclosed a separate water basin (16). The basin (16) must be a reflective material or white surface to maximize reflection to attract the insects.

The Overhang or Marquis (FIGS. 3A, 4)

An overhang (22) below the lid and above the opening into the trap should be wide enough to prevent the light from being viewed directly by flying insects. The functional purpose is to present a reflected glow rather than direct light. It also has an aesthetic purpose of preventing direct view of the light by people in the vicinity of the trap. Experience shows that people dislike looking directly at the light. This area would also provide a location for displaying the symbol of this trap—a chameleon catching a flying insect.

The Light (FIGS. 1, 1B, 2B and 31)

This attractant light insect trap uses a special fluorescent light bulb in the ultraviolet spectrum, manufactured by General Electric in several wattage (from 4 watts to 60 watts). The UV light in its Manufactured bracket (14) is installed inside the lid of the container (12).

The Liquid Used in the Trap (FIGS. 2A, 2B, 3B)

The light (14) is suspended over a basin of water (16) that has had the surface tension eliminated by a surfactant. Generally a commercial detergent or water softener is used; clear oil may be used but it is not advisable because the oil creates disposal problems.

Mosquitoes, moths and other star navigating insects are attracted to the reflected ultraviolet light within a container. The design of the container limits any reflection of the light on to surfaces outside the container. The light fixture is hidden from direct sight lines. The brightest light which attracts the insects shines primarily from the water surface within the container. Insects attracted to the light reflection on the water surface are trapped by the water which has had its surface tension removed by the addition of a surfactant.

Certain insects (star navigators, crop damaging insects and mosquitoes) are attracted to the glow of the ultraviolet light from the surface of the liquid container. When they fly into the device and close to the source (the bulb), they find the light too intense and fly toward its reflection in the soapy water below. Once they hit the water, the lack of surface tension prevents them from escaping the water.

The device will attract and kill the maximum number of night flying insects in any given area. Preferably it employs a light ray in the harmless range of the ultraviolet (UV) spectrum. All night flying insects (star navigators), such as mosquitoes and moths are compelled by instinct to fly toward this particular ray. When so used, the device will not attract or harm the principal pollinating insects such as honey bees and butterflies; nor will it attract house flies or fleas. (House flies are attracted to scents not to light rays.)

An advantage of the design is that the light rays are prevented from being reflected outside the trap. Otherwise, any star navigator that arrives at the outside reflection will land there and remain there until daylight. At daylight, a mosquito will fly to any still water and lay its eggs. A moth will fly off to nearby plants and lay its caterpillar producing eggs. Consequently, if the light is not contained within the trap, its effectiveness is greatly reduced.

The device has all of the necessary design elements to prevent the UV rays from escaping the trap. These elements include a light source mounted under the top, the light-containing configuration of the back and side walls, and a non-reflecting, black interior. At the same time, the light is mounted over a white or light reflective basin containing water which has no surface tension. The water will create a glow of UV light that will be seen by star navigators and draw them into the trap. Once in the trap, the insects will end up in the water and never get out alive. The invention proposed herein, in all field tests, performed with remarkable effectiveness the capture and killing of large numbers of mosquitoes, moths, and other star navigator insects.

The device is to simple to produce and economical to operate. It utilizes standard, nontoxic, readily available products that will not harm animal life or the environment. It can be produced and sold at retail for a price that any household of modest income can afford. (It uses only 10 watts of electricity and even could be operated with rechargeable batteries.)

Hence, the invention provides a device for attracting, trapping, and subsequently killing night flying insects that combines a covered vessel that has an opening at one side and has a dark matte inner surface, an ultra-violet light in an electrical activation bracket that is mounted underneath the inside of the top of the vessel and above the direct line of sight of the side opening of the vessel, a light colored container is enclosed in the lower section of the vessel, below the side opening, which contains a liquid which has no surface tension whereby the reflection of the ultraviolet light is cast onto the surface of the liquid in the lower part of the vessel creating a light glow on the liquid surface thus attracting the said insects to the water surface rather than directly to the light; whereby upon hitting the surface of the liquid, the insects are unable to fly off the liquid due to the lack of surface tension and thus are trapped in the liquid and die.

Although the foregoing invention has been described in some detail by way of illustration and example for purposes of clarity and understanding, it will be obvious that certain changes and modifications may be practiced within the scope of the invention, as limited only by the scope of the appended claims.

1. An insect trapping device having a light source, a liquid container disposed beneath said light source having an open surface, and means for preventing said light source from being viewed from a position normal to said axis, wherein light from said light source is reflected from the surface of a liquid placed in said liquid container, and wherein said reflected light is visible when viewed from a position normal to said axis.

2. The device of claim 1 wherein the lining of said liquid container is coated with a light reflecting material.

3. The device of claim 2 wherein the remaining interior surfaces of said device are coated with a light absorbing material.

4. The device of claim 1 wherein the said light source emits light in an ultraviolet spectrum that lures night flying insects to said liquid surface.

5. The device of claim 1 wherein said means for preventing said light source from being viewed from a position normal to said axis comprises a light occluding barrier surrounding the perimeter of said light source.

6. An insect trapping device, said device having a vertical axis with a light source positioned over a liquid container open to the surface along said axis, wherein said device comprises means for preventing said light source from being viewed from a distance from said device, wherein light from said light source is reflected from the surface of a liquid placed in said liquid container, and wherein surface reflected light is visible when viewed at said distance from said device.

7. The device of claim 6 wherein the lining of said liquid container is coated with a light reflecting material.

8. The device of claim 7 wherein the remaining interior surfaces of said device are coated with a light absorbing material.

9. The device of claim 6 wherein the said light source emits light in an ultraviolet spectrum that lures night flying insects to said liquid surface.

10. The device of claim 6 wherein said means for preventing said light source from being viewed from at a distance from said device comprises a light occluding barrier surrounding the perimeter of said light source.
